(19) United States
(12) Patent Application Publication
(10) Pub. No.: US 2026/0224942 A1
(43) Pub. Date: Aug. 6, 2026

(54) MICROMOBILITY DEVICE WITH SIMULATED RESISTANCE

(71) Applicant: Also, Inc., Palo Alto, CA (US)

(72) Inventor: Christopher YU, Menlo Park, CA (US)

(73) Assignee: Also, Inc., Palo Alto, CA (US)

(21) Appl. No.: 19/530,980

(22) Filed: Feb. 5, 2026

Related U.S. Application Data
(60) Provisional application No. 63/754,829, filed on Feb. 6, 2025.

(51) Int. Cl. A63B 24/00; A63B 22/06

(52) U.S. Cl. CPC A63B 24/0075; A63B 22/0605; A63B 24/0087; A63B 2022/0635

(57) ABSTRACT

A bike can include a frame, a first wheel and a second wheel rotatably coupled with the frame, a drive unit coupled with the frame, and a control device. The drive unit can include a generator and a pedal assembly. The drive unit can rotate the second wheel. The control device can alter an operation of the generator to selectively vary an amount of force to move the pedal assembly to drive the second wheel.

### CROSS-REFERENCE TO RELATED PATENT APPLICATION

This application claims the benefit of and priority to U.S. Provisional Patent Application No. 63/754,829, filed February 6, 2025, the entirety of which is incorporated by reference herein.

### INTRODUCTION

Bicycles can include an electric motor that receives power from a battery.

### SUMMARY

The technical solutions are generally directed to a micromobility device such as a bicycle (bike). The bike can include at least one pedal assembly, at least one drive unit (e.g., a propulsion system), and at least one wheel. The drive unit can rotate the wheel to propel the bike. The pedal assembly can be coupled with the drive unit such that a mechanical force applied to the pedal assembly by a user can cause the drive unit to rotate the wheel to propel the bike. The drive unit can rotate the wheel in absence of a mechanical force provided by the user to the pedal assembly. For example, the bike can include a battery to power the drive unit without application of a mechanical force to the pedal assembly by the user. The bike can be propelled (i) by a mechanical force provided by the user to the pedal assembly, (ii) by an electrical force provided by a battery to a motor, or (ii) some combination thereof. In this way, movement of the bike does not depend entirely on a mechanical force provided by a user, which allows for a speed of the bike or a force required by the user to rotate a pedal to be varied independently of the other. For example, a force required by a user to rotate a pedal (e.g., pedal assembly) of the bike can be independent from a speed of the bike. Stated otherwise, the force required by the user can be selected or determined to provide a particular riding experience, such as to obtain a particular level of exercise or leisure, independent of a speed of bike.

The drive unit of the bike can include a generator coupled with a pedal of the bike. The bike can include an amount of force required by a user to actuate the generator (e.g., to rotate the shaft of the generator) that can be varied by the generator or some component couple thereto (e.g., a control device). For example, an amount of force required to actuate the generator can vary so as to require a certain force or forces from a user to pedal the bike and provide the user with a desired riding experience (e.g., a certain level of exercise, a certain amount of resistance, etc.). The control device of the bike can selectively alter an amount of force required by a user to rotate the pedal by altering an operation of the generator. The control device can cause the generator to require a certain force or forces from the user according to a workout program, a training schedule, or some other operating parameter. The work out program, training schedule, or operating parameter can be selected by a user (e.g., via a user device) can further be adapted, according to sensed data (e.g., measured heart rate data).

At least one aspect is directed to a bike. The bike can include a frame. The bike can include a first wheel and a second wheel. The first wheel and the second wheel can be rotatably coupled with the frame. The bike can include a drive unit. The drive unit can be coupled with the frame. The drive unit can include a first geartrain, a generator, a second geartrain, and a pedal assembly. The generator can include a shaft. The pedal assembly can be rotatably coupled with the shaft. The pedal assembly can rotate the shaft based on a required force provided by a user to the pedal assembly. The drive unit can be operatively coupled with the second wheel via the second geartrain. The pedal assembly can be selectively coupled with the second wheel via the first geartrain and the second geartrain. The drive unit can rotate the second wheel. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the required force in response to an input.

At least one aspect is directed to a system. The system can include a bike. The bike can include a frame. The bike can include a first wheel and a second wheel. The first wheel and the second wheel can be rotatably coupled with the frame. The bike can include a drive unit. The drive unit can be coupled with the frame. The drive unit can include a generator and a pedal assembly. The pedal assembly can be rotatably coupled with a shaft of the generator. The pedal assembly can rotate the shaft based on a force provided to the pedal assembly. The bike can include a battery. The battery can be detachably coupled with the frame. The bike can be operatively coupled with the drive unit. The battery can cause the drive unit to rotate the second wheel. The bike can include a control device. The control device can be operatively coupled to the drive unit. The control device can alter an operation of the generator to selectively vary the force provided to the pedal assembly in response to an input.

At least one aspect is directed to a method. The method can include receiving, by a control device of a bike, a first input indicative of a workout program. The method can include operating, by the control device, based at least on the first input, a drive unit of the bike to rotate a wheel of the bike with a first amount of force input via a pedal assembly according to an operation of the bike. The method can include receiving, by the control device, via a sensor, a second input indicative of a biometric of a user. The method can include altering, by the control device, based on the second input, the operation of the bike to rotate the wheel of the bike with a second amount of force via the pedal assembly. The second amount of force can be different from the first amount of force.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example bike, in accordance with some aspects.

FIG. 2 depicts a drive unit of a bike, in accordance with some aspects.

FIG. 3 is a block diagram of a system that includes an example drive unit of a bike, in accordance with some aspects.

FIG. 4 is a block diagram of a system to facilitate communication between one or more bikes, in accordance with some aspects.

FIG. 5 is a flow chart of a method of operating a bike, in accordance with some aspects.

FIG. 6 is a block diagram illustrating an architecture for a computing system that can be employed to implement elements of the systems and methods described and illustrated herein, in accordance with some aspects.

### DETAILED DESCRIPTION

Following below are more detailed descriptions of various concepts related to, and implementations of, methods, apparatuses, and systems of integrating feedback systems into bicycles. The various concepts introduced above and discussed in greater detail below may be implemented in any of one or more numerous ways.

The technical solutions are generally directed to a micromobility device, such as a bicycle (bike). The bike can include at least one pedal assembly, at least one drive unit (e.g., a propulsion system), and at least one wheel. The drive unit can rotate the wheel to propel the bike. The pedal assembly can be coupled with the drive unit such that a mechanical force applied to the pedal assembly by a user can cause the drive unit to rotate the wheel to propel the bike. The drive unit can rotate the wheel in absence of a mechanical force provided by the user to the pedal assembly. For example, the bike can include a battery to power the drive unit without application of a mechanical force to the pedal assembly by the user. The bike can the propelled by a mechanical force provided by the user to the pedal assembly, by an electrical force provided by a battery to a motor, or some combination thereof.

In this way, movement of the bike does not depend entirely on a mechanical force provided by a user, which allows a speed of the bike or a force applied or required by the user to rotate a pedal to be varied independently of each other. For example, a force applied or required by a user to rotate a panel of the bike can be independent from a speed of the bike, such that the force applied or required by the user can be selected or determined to provide a particular riding experience, such as to obtain a particular level of exercise or leisure, independent of a speed of bike. The drive unit of the bike can include a generator coupled with a pedal of the bike.

The bike can include an amount of force applied or required by a user to actuate the generator (e.g., to rotate a shaft of the generator) that can be varied by the generator or some component couple thereto (e.g., a control device). For example, an amount of force applied or required to actuate the generator can vary so as to require a certain force or forces from a user to pedal the bike and provide the user with a desired riding experience (e.g., a certain level of exercise). The control device of the bike can selectively alter an amount of force applied or required by a user to rotate the pedal by altering an operation of the generator. The control device can cause the generator to require a certain force or forces from the user according to a workout program, a training schedule, or some other operating parameter. The workout program, training schedule, or operating parameter can be selected by a user (e.g., via a user device). The workout program, training scheduled, or operation parameter can be adapted according to sensed data (e.g., measured heart rate data).

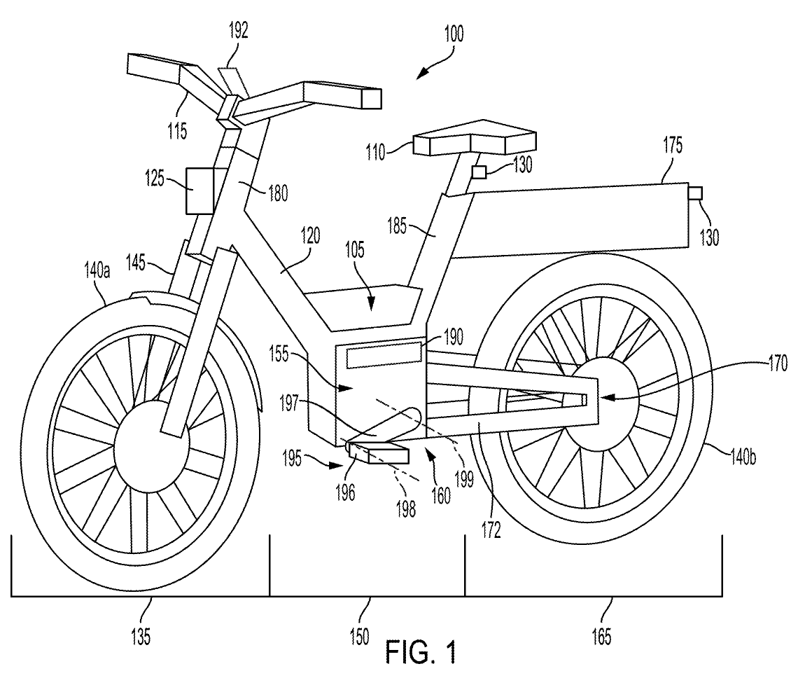

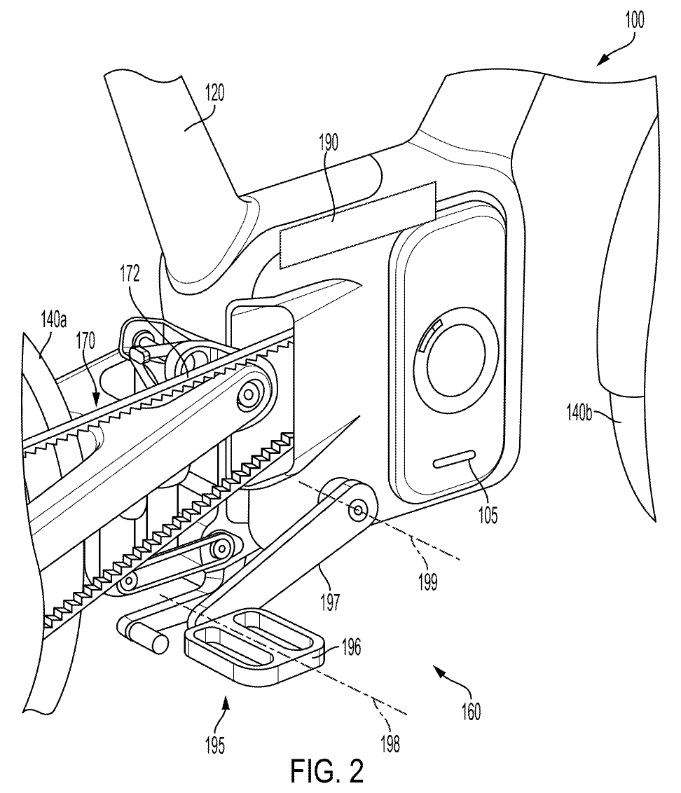

FIGS. 1-2, among others, depict example perspective views of a micromobility device 100, which can be referred to herein and is shown in FIG. 1 as bike 100. The bike 100 can be an electric bike installed with at least one battery pack or battery assembly (shown as battery pack 105). The bike 100 can be a human-operated bike. The bike 100 can include single rider bicycles, tandem bicycles, cargo bicycles, motor-assist bicycles, pedicabs, electric-assist bicycles, road bicycles, mountain bicycles, or unicycles, among others. The battery pack 105 can be used as an energy storage system to power a building, such as a residential home or commercial building. The bike 100 can be fully electric or partially electric (e.g., pedal-powered). The bike 100 can be fully autonomous, partially autonomous, semi-autonomous, or unmanned. The bike 100 can also be human operated or non-autonomous. A human operator or the rider of the bike 100 can sit on a saddle 110 to operate the bike 100. The rider of the bike 100 can steer, grip, balance, or otherwise control the bike 100 using handlebar 115.

The bike 100 can include a frame 120. The frame 120 can support various components of the bike 100, such as the handlebar 115, the saddle 110, the battery pack 105, at least one front light assembly (shown as front light assembly 125), and at least one rear light assembly (shown as rear light assembly 130). The frame 120 can span a front portion 135 of the bike 100. The front portion 135 can support, be coupled with, or include, for example, one or more wheels of the bike 100, a fork 145 of the bike 100, a head tube 180 of the bike 100, the handlebar 115, the front light assembly 125, among other components. The bike 100 can include two or more wheels (e.g., front wheel 140a and rear wheel 140b). The frame 120 can span a middle portion 150 (e.g., a central portion) of the bike 100. The middle portion 150 can support, be coupled with, or include, for example, the saddle 110, the battery pack 105, a drive unit 155 of the bike 100, a crank assembly 160 of the bike 100, or a top tube 185 of the bike 100, among other components.

The frame 120 can span a rear portion 165 of the bike 100. The rear portion 165 can support, be coupled with, or include, for example, the rear wheel 140b, the rear light assembly 130, a traction assembly 170 of the bike 100, a drivetrain 172 of the bike 100, or a rear member 175 of the bike 100, among other components. The drivetrain 172 can be a chain, gear, belt, or some combination thereof that couples the drive unit 155 (or the traction assembly 170) with the rear wheel 140b such that the drive unit 155 can rotate or drive the rear wheel 140b. The rear member 175 can be a rear fender, a rack configured to stow or support luggage or some other object, a child seat, a pet carrier, a basket, or some other object.

The battery pack 105 can include at least one battery, at least one battery module, or at least one battery cell. The battery pack 105 can be electrically coupled with the bike 100 (e.g., to the drive unit 155, to the front light assembly 125, the rear light assembly 130, or some other component(s)). For example, the battery pack 105 can provide electrical energy to the bike 100 to power the bike 100. The battery pack 105 can provide electrical energy to the drive unit 155 to cause the drive unit 155 to operate (e.g., to rotate the front wheel 140a or the rear wheel 140b). The battery pack 105 can be installed or placed within the bike 100. For example, the battery pack 105 can be installed on the frame 120 of the bike 100 or within one or more of the front portion 135, the middle portion 150, or the rear portion 165.

The battery pack 105 can be integrally coupled with the frame 120 such that the battery pack 105 is not removable. The battery pack 105 can be detachably coupled with the frame 120 such that the battery pack 105 can be removed (e.g., to charge one or more batteries of the battery pack 105, replace with a second battery pack, etc.). The battery pack 105 can include or connect with at least one busbar (e.g., a current collector element). For example, the busbar can include electrically conductive material to connect or otherwise electrically couple the battery pack 105 with other electrical components of the bike 100 to provide electrical power to various systems or components of the bike 100, such as the front light assembly 125, the rear light assembly 130, or some other system.

The bike 100 can include a control device 190 and a user interface 192. The control device 190 can be coupled with the user interface 192. The user interface 192 can be or include an interface (e.g., a graphical user interface, at least one button, switch, or actuator, or some other interface) to allow a user (e.g., a rider) to affect or influence an operation of the bike 100. For example, a user can make a selection via the user interface 192. The user interface 192 can provide a signal to the control device 190, where the control device 190 can further control or otherwise affect an operation of the bike 100. For example, the control device 190 can affect an operation of the drive unit 155 or some component thereof (e.g., a generator of the bike 100) based on a user input provided via the user interface 192. The user interface 192 can be coupled with the bike 100 (e.g., physically coupled with the handlebar 115 of the bike 100). The user interface 192 can be remote or external to the bike 100, such as a mobile device (e.g., a phone, a tablet, a smart watch, or some other mobile device).

The drive unit 155 can include the crank assembly 160 and the traction assembly 170. The crank assembly 160 can receive a mechanical force from a user (e.g., a mechanical force against a pedal). The traction assembly 170 can include the rear wheel 140b, the drivetrain 172, a geartrain, and a motor. At least one of the geartrain or the motor (of the traction assembly 170) can cause the rear wheel 140b to rotate (e.g., drive the rear wheel 140b). The geartrain or the motor (of the traction assembly 170) can be driven by operation or movement of the crank assembly 160. The drive unit 155 can be a hybrid propulsion system, a manual powered propulsion system (e.g., a mechanical force applied by a user to a pedal of the bike 100, a battery power propulsion system (e.g., power provided by the battery pack 105), or a combination thereof. For example, the drive unit 155 can allow for one or more of (i) a user to pedal the bike 100 to propel the bike 100, (ii) utilization of power provided by the battery pack 105 to propel the bike 100, or (iii) utilization of a combination of manual force against the pedal and the power provided by the battery pack 105 to propel the bike 100.

The crank assembly 160 can include at least one pedal assembly (shown as pedal assembly 195). The crank assembly 160 can receive mechanical power from a user via the pedal assembly 195. For example, the pedal assembly 195 can include a pedal 196 and a shaft 197. The pedal 196 can be rotatably coupled to the shaft 197 and the pedal 196 can rotate relative to the shaft 197 about a pedal axis 198. The shaft 197 can rotate about a shaft axis 199. The crank assembly 160 can be movably coupled with the traction assembly 170. For example, movement or rotation of the pedal 196 or the pedal assembly 195 can result in movement, operation, or activation of the traction assembly 170 (or the drivetrain 172) to drive the rear wheel 140b.

The drive unit 155 can be a series or parallel system. The drive unit 155 can be configured to modulate or switch between both. For example, the drive unit 155 can switch between two configurations: a series configuration and a parallel configuration. The series configuration can provide a single path for power to travel to drive the bike 100. The series configuration can include an electrical connection between the crank assembly 160 and the traction assembly 170, which provides for the transfer of electrical power from the crank assembly 160 to the traction assembly 170. The parallel configuration can include two or more discrete or separate paths for which power (e.g., mechanical, electrical, etc.) can transfer from the crank assembly 160 to the traction assembly 170.

The drivetrain 172 can operatively couple the drive unit 155 with the rear wheel 140b. The drivetrain 172 can mechanically couple the drive unit 155 with the rear wheel 140b such that operation of the drive unit 155 can cause the rear wheel 140b to rotate to propel the bike 100, for example. The drivetrain 172 can be or include a chain or belt. The drivetrain 172 can extend between and mechanically couple the traction assembly 170 with the rear wheel 140b. For example, the drive unit 155 can be disposed away (e.g., spaced apart from) the rear wheel 140b with the drivetrain 172 extending between the traction assembly 170 and the rear wheel 140b. The drivetrain 172 can transfer mechanical power from the drive unit 155 or the crank assembly 160 (e.g., power originating from the user applying a force to the crank assembly 160 via the pedal assembly 195 or power from the battery pack 105) to the rear wheel 140b to drive the bike 100.

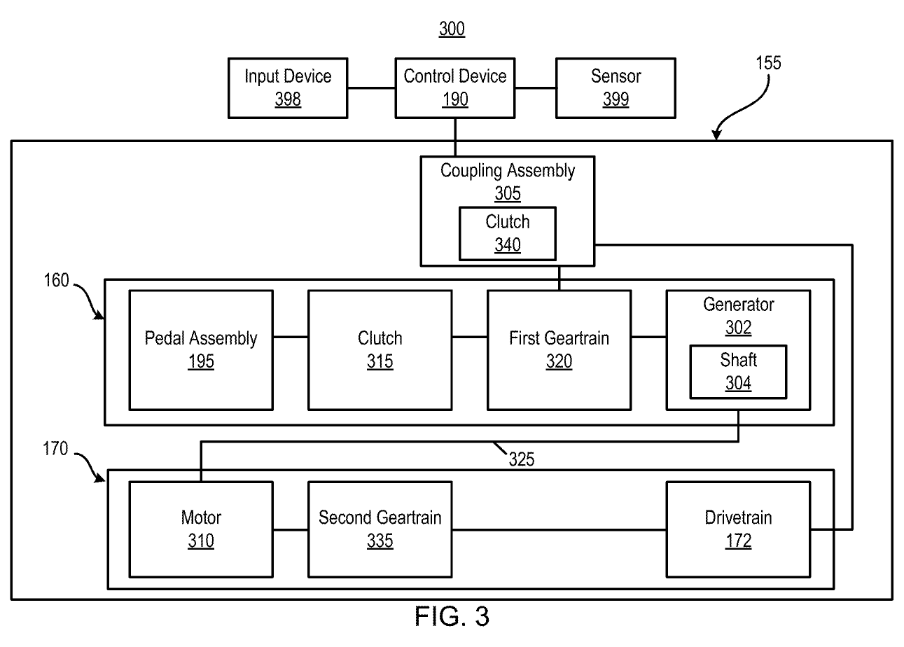

FIG. 3 depicts a schematic diagram of a system 300 that includes one or more components of the bike 100. As shown in FIG. 3, the drive unit 155 is communicably coupled with the control device 190. Mechanical power (from the crank assembly 160) can be converted to electrical power via a generator 302 of the drive unit 155. The electrical power can be transferred to a motor 310 of the traction assembly 170 via an electrical bus 325 of the drive unit 155. The motor 310 can convert the electrical energy back to mechanical energy to drive the drivetrain 172 or the bike 100 (e.g., the rear wheel 140b). To switch between one or more systems or configurations (e.g., series configuration, parallel configuration, etc.), an actuatable coupling assembly (shown as coupling assembly 305 of the drive unit 155) may be actuated or otherwise utilized. The coupling assembly 305 can be actuated automatically or manually.

When engaged (e.g., actuated) or operated, the coupling assembly 305 can create a mechanical path that bypasses the generator 302 and the motor 310 such that the mechanical energy (produced during rotation of the pedal assembly 195) is directly used to drive or propel the bike 100 via the drivetrain 172. Stated otherwise, the coupling assembly 305 can establish a mechanical connection directly between the traction assembly 170 and at least one of the pedal assembly 195 or a geartrain of the crank assembly 160. The coupling assembly 305 can be actuated to couple the crank assembly 160 with the traction assembly 170, such that mechanical energy is transferred from the crank assembly 160 to the traction assembly 170. The coupling of the crank assembly 160 with the traction assembly 170 can be at one or more desired times (e.g., no battery power, need additional torque, etc.). The electrical connection (via the electrical bus 325) between the crank assembly 160 and the traction assembly 170 can remain constant, while the mechanical connection can be intermittent based on operation of the coupling assembly 305.

The coupling assembly 305 can selectively mechanically couple the crank assembly 160 with the traction assembly 170 (e.g., the drivetrain 172). With the crank assembly 160 mechanically coupled with the traction assembly 170, the traction assembly 170 can receive mechanical power directly from the pedal assembly 195. The coupling assembly 305 can be or include a clutch 340. The clutch 340 can selectively engage or disengage the crank assembly 160 and the traction assembly 170. For example, the clutch 340 can selectively mechanically couple a geartrain (shown as first geartrain 320) of the crank assembly 160 with the drivetrain 172. The mechanical coupling, via the clutch 340, between the first geartrain 320 and the drivetrain 172 can bypass the generator 302. The clutch 340 can be actuated manually or automatically to engage and disengage the coupling assembly 305 to selectively mechanically couple or decouple the crank assembly 160 with the traction assembly 170.

The coupling assembly 305 can be coupled with the control device 190. The control device 190 can automatically actuate the clutch 340. For example, the control device 190 can automatically actuate the clutch 340 based on riding conditions (e.g., bike speed, pedal speed, include, incline of a ground surface, decline of a ground surface, etc.). The control device 190 can be a part of or coupled with the drive unit 155. In other examples, the control device 190 can be associated with the bike 100 generally and can be communicably coupled with a control device (e.g., a controller, a printed circuit board assembly, or some other control device) that is part of the drive unit 155 specifically. In either case, the control device 190 can control or actuate the coupling assembly 305 to couple or decouple the crank assembly 160 with the traction assembly 170.

The drive unit 155 can switch between a first configuration and a second configuration. In the first configuration, the crank assembly 160 can be only electrically coupled with the traction assembly 170. For example, the only connection between the crank assembly 160 and the traction assembly 170 (in the first configuration) can be the electrical connection via the electrical bus 325. In the first configuration, the coupling assembly 305 does not form a mechanical connection between the crank assembly 160 and the traction assembly 170. In the second configuration, the crank assembly 160 can be both electrically and mechanically coupled with the traction assembly 170. For example, in the second configuration, the coupling assembly 305 can create a mechanical connection between the crank assembly 160 and the traction assembly 170 with the crank assembly 160 still electrically coupled with the traction assembly 170 via the electrical bus 325. In the second configuration, the coupling assembly 305 can selectively couple the first geartrain 320 with the drivetrain 172 to provide for the transfer of mechanical power from the crank assembly 160 to the traction assembly 170.

The crank assembly 160 can include at least one clutch (shown as clutch 315). The clutch 315 can be mechanically coupled with the pedal assembly 195. The clutch 315 can be a one-way clutch or a two-way clutch, for example. The clutch 315 can engage the first geartrain 320. For example, the clutch 315 can selectively engage the first geartrain 320 when a user moves the pedal assembly 195 in a predetermined direction. The first geartrain 320 can include any number of gears disposed in any configuration. The first geartrain 320 can be a single speed geartrain. For example, the first geartrain 320 can have a fixed ratio. The shaft 197 can be operatively coupled to the first geartrain 320. For example, rotation of the shaft 197 (about the shaft axis 199) can cause the first geartrain 320 or a portion thereof to rotate. Such operative coupling of the shaft 197, with the first geartrain 320, can allow for mechanical rotation of the first geartrain 320 by applying a mechanical force to the pedal 196 to rotate the shaft 197.

The crank assembly 160 can include the generator 302. The crank assembly 160 can include or be operatively coupled with the battery pack 105. The mechanical power provided by the pedal assembly 195 (e.g., via application of force to the pedal 196) can be transferred to the generator 302 via the clutch 315 and the first geartrain 320. For example, the first geartrain 320 can be mechanically coupled with the generator 302. The generator 302 can convert the mechanical power provided via the first geartrain 320 (e.g., power received from operation of the pedal assembly 195) into electrical power. The electrical power can be stored in the battery pack 105 or can be transferred to another component of the bike 100 (e.g., the motor 310) to power another component of the bike 100, such as the drivetrain 172. The crank assembly 160 can provide mechanical power (provided by the pedal assembly 195) to at least one of the generator 302 or the drivetrain 172. The crank assembly 160 can provide electrical power (provided by the generator 302) to at least one of the battery pack 105 or the motor 310.

The generator 302 can impose a resistance on the pedal assembly 195. For example, the generator 302 can provide a force feedback to the pedal assembly 195 to increase an amount of mechanical force (applied by a rider) to rotate the shaft 197. In this way, an amount of force (applied to the pedal 196 or the pedal assembly 195) to rotate the shaft 197 can be modulated or selectively adjusted. Stated otherwise, the generator 302 can provide simulated or adjustable amounts of resistance to modulate an amount of force that results in rotation of the shaft 197 or in driving of the rear wheel 140b.

In various circumstances, the amount of force (applied by a user) to propel the bike 100 can vary. For example, the bike 100 can be propelled at a first speed by a first mechanical force applied to the pedal assembly 195 and without assistance from the battery pack 105 or the motor 310, where the pedal assembly 195 is subject to a first resistance from the generator 302. In another example, the bike 100 can be propelled at the same first speed, but by a second mechanical force applied to the pedal assembly 195 and without assistance from the battery pack 105 or the motor 310, where the pedal assembly 195 is subject to a second resistance from the generator 302. The first force (applied to the pedal assembly 195) and the first resistance imposed by the generator 302 can be less than or greater than the second force (applied to the pedal assembly 195) and the second resistance imposed by the generator 302, respectively. In this way, the bike 100 can be propelled at a certain speed, but with varying amounts of mechanical force applied or provided to the pedal assembly 195. For example, a user can exert more force in one circumstance and less force in another circumstance, even though a speed of the bike 100 can be substantially (e.g., ± 1%) the same in both circumstances.

The generator 302 can be electronically controlled to modulate (e.g., vary, change, etc.) a force required to rotate the pedal assembly 195 and propel the bike 100. For example, the generator 302 can include a shaft 304 that is operatively coupled with the shaft 197 or the first geartrain 320, such that rotation of the shaft 197 causes a corresponding rotation of the shaft 304. The generator 302 can be an electrical generator that can electrically alter an amount of mechanical force required to rotate the shaft 304. For example, the shaft 304 can require a first mechanical force to rotate with the generator 302 under a first current load, but a second mechanical force with the generator 302 under a second current load. The current load of the generator 302 can be modulated by the control device 190. In other examples, the generator 302 can exhibit or generate a magnetic field in response to an electrical current, where the magnetic field opposes rotation of the shaft 304. In such examples, the control device 190 can alter the magnetic field of the generator 302 to modulate an amount of force applied via the pedal assembly 195 to rotate the shaft 304.

The electrical bus 325 can be an electrically conductive member that can conduct electricity to electrically couple the crank assembly 160 with traction assembly 170. The crank assembly 160 can be constantly electrically coupled with the traction assembly 170, via the electrical bus 325. For example, the electrical bus 325 can create a permanent electrical connection between the crank assembly 160 and the traction assembly 170. Electrical power can be transferred from the generator 302 or the battery pack 105 to the traction assembly 170 via the electrical bus 325.

The electrical bus 325 can electrically couple at least one of the generator 302 or the battery pack 105 with the motor 310. The electrical power created by the generator 302 or stored by the battery pack 105 can be transferred to the motor 310 via the electrical bus 325. The traction assembly 170 can receive the electrical power from at least one of the generator 302 or the battery pack 105 to operate the drivetrain 172 to drive the rear wheel 140b. For example, the motor 310 can convert electrical power (received via the electrical bus 325) to mechanical power to drive the rear wheel 140b. The motor 310 can be mechanically coupled with a geartrain (shown as a second geartrain 335) of the traction assembly 170. The motor 310 can use electrical power (received via the electrical bus 325) to drive the second geartrain 335.

The drivetrain 172 can be mechanically coupled with the second geartrain 335. The drivetrain 172 can receive mechanical power, from the motor 310, via the second geartrain 335. The rear wheel 140b can be constantly or permanently mechanically coupled with the second geartrain 335, via the drivetrain 172. For example, the mechanical connection between the rear wheel 140b and the second geartrain 335 can remain constantly intact.

The first configuration (as described herein) can represent a series configuration of the drive unit 155 (e.g., a series hybrid system). For example, all of the power to drive the bike 100 can follow a single path. For example, power can initiate at the pedal 196. The power (initiated at the pedal 196) can be a first mechanical power. The first mechanical power can transfer from the pedal assembly 195 to the generator 302. The generator 302 can convert the first mechanical power to electrical power. The electrical power can be transferred to the motor 310 via the electrical bus 325. The motor 310 can convert the electrical power to a second mechanical power. The second mechanical power can be transferred from the motor 310 to the drivetrain 172. The drivetrain 172 can be coupled with a traction element (e.g., wheel 140) of the bike 100. The second mechanical power can cause the drivetrain 172 to drive the rear wheel 140b and ultimately drive the bike 100.

The second configuration (as described herein) can represent a parallel configuration of the drive unit 155 (e.g., a parallel hybrid system). For example, the power to drive the bike 100 can flow through separate paths. A first path of the second configuration can include transferring power from the pedal assembly 195 to the generator 302, and ultimately to the motor 310, before reaching the drivetrain 172. A second path of the second configuration (which can be discrete and separate from that of the first path) can include the transferring of power from the pedal assembly 195 directly to the drivetrain 172 (e.g., without power being converted into electrical energy by the generator 302). For example, the coupling assembly 305 can mechanically couple the crank assembly 160 with the rear wheel 140b (via the traction assembly 170) such that the generator 302 and motor 310 are at least partially bypassed.

In the second configuration, mechanical power (which is initiated at the pedal 196 or the pedal assembly 195) can be directly applied or routed to the drivetrain 172, without first being converted to electrical power and then being converted back to a second mechanical power. In the second configuration, the mechanical power (initiated at the pedal 196 or the pedal assembly 195) can be transferred to the drivetrain 172 in various combinations. For example, a first amount of mechanical power can be initiate at the pedal assembly 195. A first portion of the first mechanical power can be transferred directly to the drivetrain 172, via the coupling assembly 305. A second portion of the first mechanical power can be transferred to the generator 302 and the motor 310, and converted into a second mechanical power, prior to reaching the drivetrain 172. The first portion of the first mechanical power can be greater than, less than, or equal to the second portion of the first mechanical power, and can vary according to an operation of the bike 100, an input of the user, or otherwise.

The control device 190 can control given amounts or portions of power that are provided directly or indirectly to the traction assembly 170 or control which paths power follows. For example, the control device 190 can cause the coupling assembly 305 to mechanically couple the crank assembly 160 with the traction assembly 170. In this example, the control device 190 can (via the coupling assembly 305) route all mechanical power from the pedal assembly 195 to the drivetrain 172 to drive the rear wheel 140b. The distribution or routing of power (between the generator 302 and the traction assembly 170) can be based on operating conditions of the bike 100. The operating conditions can include one or more of road conditions (e.g., incline, decline, flat, etc.), pedal speed, bike speed, or detected amounts of exertion on part of the user of the bike 100. As an example, with the bike 100 traveling up an incline, the control device 190 can determine how much of the mechanical power can be provided directly to the rear wheel 140b and how much to provide to the generator 302. The distribution of power can be, for example, based at least partially on differences or variances between the bike speed and equivalent pedal speed of the bike 100. For example, with the pedal speed exceeding the bike speed, the control device 190 can cause the coupling assembly 305 to mechanically couple the crank assembly 160 with the traction assembly 170. As another example, with the bike speed exceeding the pedal speed, the control device 190 can route mechanical power to the generator 302.

The amount of power directed to or routed to each path (with the bike 100 in the second configuration) can be based on a difference between the equivalent pedal speed and the bike speed. For example, the control device 190 can compare the difference to a predetermined threshold. With a difference that exceeds the threshold, the control device 190 can cause more power from the pedal assembly 195 to go directly to drivetrain 172 (to drive the rear wheel 140b). With a difference that does not exceed the threshold, the control device 190 can cause more power to go to the generator 302. For example, more power can be provided directly to the drivetrain 172 (with the bike 100 on a steeper incline) due to the motor 310 and second geartrain 335 not being able to provide enough torque to drive the bike 100 up the incline.

The control device 190 can selectively alter amounts of force or power to act on or operate the pedal assembly 195. For example, and as described herein, the pedal assembly 195 can be operatively coupled to the generator 302, where the generator 302 can selectively alter an amount of force for the pedal assembly 195 to rotate the shaft 304. The shaft 304 can be operatively coupled with the shaft 197 such that rotation of the shaft 197 causes a corresponding rotation of the shaft 304. Accordingly, the selective alteration (of the force to rotate the shaft 304) can result in a variation or an adjustment to an amount of force (applied to the pedal assembly 195) to drive the bike 100.

The bike 100 can be propelled via (i) mechanical force or mechanical power applied to the pedal assembly 195, (ii) electrical power provided to the motor 310, or (ii) by some combination thereof. As a result, the bike 100 can be propelled in a manner and at a pace that does not depend (at least entirely) on an amount of force supplied to the pedal assembly 195. For example, a user can apply (to the pedal assembly 195) a first amount of force to propel the bike 100 at a first speed. In this example, the battery pack 105 can further provide power to the motor 310 to drive the rear wheel 140b and propel the bike 100. As another example, a user can apply (to the pedal assembly 195) a first amount of force to propel the bike 100 at a second speed. In this example, the battery pack 105 does not provide power to the motor 310, or provides a lesser amount of power to the motor 310. As a result, the second speed can be less than the first speed, despite the user applying (to the pedal assembly 195) the same amount of force in both examples. In another example, a user can apply a second amount of force to propel the bike 100 at the first speed, the second speed, or at some other speed. In this example, the second amount of force can be more or less than the first amount of force. In these various examples, the speed of the bike 100 can be an operating parameter of the bike 100 that is fully independent from an amount of force applied to the pedal assembly 195.

The speed of the bike 100 can be an operating parameter that is independent, discrete, or separate from an amount of force supplied (by a user of the bike 100) to the pedal assembly 195. As a result, the speed of the bike or a force to propel the bike 100 at a certain speed (e.g., an amount of resistance experienced by the user) can be selectively altered to provide a particularized riding experience. For example, a particularized riding experience can be provided through the selective alternation of an amount of force to rotate the shaft 304, which thereby adjusts an amount of force (applied to the pedal assembly 195) to propel the bike 100.

As shown in FIG. 3, the control device 190 can be communicably coupled to at least one input device (shown as input device 398). The input device 398 can be or include the user interface 192, a mobile device (e.g., a cell phone, table, a smart watch, or some other mobile device), a fitness tracking device (e.g., heart rate monitor, a continuous glucose meter, pulse oximeter, or some other fitness tracking device), or some other device that can communicate with the control device 190 and provide data thereto. The input device 398 can cause the control device 190 to affect the operation of the generator 302 (e.g., to cause the generator 302 to require greater or lesser force to rotate the shaft 304) according to a program or schedule, such as a workout program or training schedule, for example.

The selective alteration (by the control device 190) of the amount of force to propel the bike 100 can be based on or in accordance to a program or schedule. For example, the control device 190 can cause the generator 302 to modulate an amount required to rotate the shaft 304 in accordance to a training schedule, a workout program, or in furtherance of some other fitness goal. As another example, a user can choose (via the input device 398) a program, schedule, or other parameter, by which the control device 190 can cause the generator 302 to control an amount of force to rotate the shaft 304 or otherwise drive the rear wheel 140b.

The input device 398 can include one or more preset programs, schedules, or other parameters. The input device 398 can include functionality to create or modify a program, schedule, or other parameter associate with adjusting or altering an amount of force to drive the rear wheel 140b. For example, a user can select a program, a schedule, or other parameter that can require the user to provide (to the pedal assembly 195) a certain amount of force to propel the bike 100. In this example, the certain amount of force can necessitate the user to undergo or otherwise experience a certain activity level (e.g., a certain level or intensity of fitness or exercise). As another example, a user can select a program within a graphical user interface of a user device (e.g., the input device 398), such that the control device 190 causes the generator 302 to require that a certain force or forces be applied (to the pedal assembly 195) to propel the bike 100. In this example, the certain force or forces can cause the user to experience a heightened level of exercise activity or a particular level of exercise activity.

The heightened level of exercise activity can be or include a level of exercise activity that causes or results in one or more physiological parameters being present or otherwise occurring. For example, the heightened level of exercise activity can result in a heart rate that exceeds a threshold or a target heart rate. As another example, the heightened level of exercise activity can result in an expenditure (by the user) of a certain amount of calories or require a certain amount of energy being output by a user. As another example, the heightened level of exercise activity can result in the generator 302 being controlled (by the control device 190) to require exertion of a certain force or forces (on the pedal assembly 195) to propel the bike 100. In this example, the certain force or forces can exceed a threshold power level, a desired torque level, or some other parameter that can be associated with or dissociated from an exercise related objective of the user.

The control device 190 can be communicably coupled with at least one sensor (shown as sensor 399). The sensor 399 can be integrated with or separate from the input device 398. For example, the sensor 399 can be a heart rate strap and the input device 398 can be a mobile device or a smart watch. The sensor 399 and the input device 398 can be coupled to each other or coupled with the control device 190. In either case, both the sensor 399 and the input device 398 can transmit data via wired or wireless communication to the control device 190. The data transmitted by or exchanged between the sensor 399, the input device 398, and the control device 190 can be used (by the control device 190) to affect an operation of the generator 302 or some other component of the bike 100. For example, a user can select, via the input device 398, a workout program that specifies a threshold heart rate above which a heart rate of the user desirably remain.

Data provided by the sensor 399 to the control device 190 can cause the control device 190 to implement a program in a personalized manner (e.g., at least partially response to a dynamic biometric input of a user). Data from the sensor 399 can include heart rate data, skin, temperature, data, sweat, rate data, or any other measurable data that is health related or otherwise related to a user of the bike 100. In various examples, data from the sensor 399 can be used by the control device 190 to adapt or otherwise modify a workout program, training schedule, or other parameter of the bike 100. For example, the control device 190 can use data from the sensor 399 in conjunction with data from the input device 398 to implement a personalized and adaptable operating mode of the bike 100.

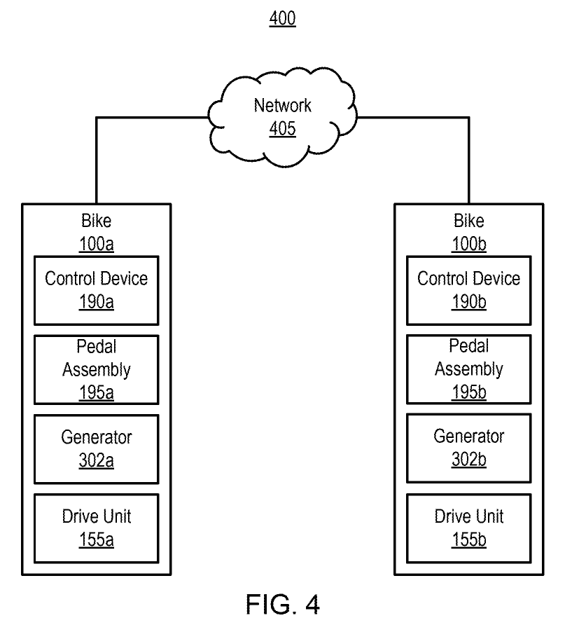

FIG. 4 depicts a block diagram of a system 400 to facilitate the exchange of data between one or more bikes. For example, as shown in FIG. 4, the system 400 includes bike 100a that is communicably coupled with bike 100b via a network 405. The network 405 can include one or more of a personal area network, a local area network, a wide area network, a cellular network, a mobile network, a peer-to-peer network, a device-to-device network, among of possibilities. The network 405 can communicably couple the bikes (e.g., the bike 100a, the bike 100b, etc.) with one another such that data or information can be exchanged between the bikes. The bike 100a and the bike 100b can include respective hardware or circuitry components, such as processors, memory devices, systems-on-chip, network devices (e.g., transmitters, transceivers, receivers, antennas, etc.), display devices, input devices, among other possible circuitry. For example, the bike 100a and the bike 100b can include respective controllers, microcontrollers, processors, or microprocessors to facilitate control of one or more aspects of the bike 100a and the bike 100b. As another example, the bike 100a and the bike 100b can include respective instances of the input device 398.

As shown in FIG. 4, among others, the bike 100a and the bike 100b include respective control devices (shown as control device 190a and control device 190b), respective generators (shown as generator 302a and generator 302b), respective pedal assemblies (shown as pedal assembly 195a and pedal assembly 195b), and respective drive units (shown as drive unit 155a and drive unit 155b). The control device 190a can control operation of the generator 302a and operation of the drive unit 155a to provide both a desired riding experience (for example, exercise intensity level) and a desired speed of the bike 100a during operation of the bike 100a. The control device 190b can control operation of the generator 302b and operation of the drive unit 155b to provide both a desired riding experience and a desired speed of the bike 100b during operation of the bike 100b.

The control device 190a and the control device 190b can communicate via the network 405 (for example, a wired or wireless communication link) so that operation of the generator 302a is coordinated with operation of the generator 302b. For example, the control device 190a can operate the generator 302a and the control device 190b can operate the generator 302b to control a range proximity between the bike 100a and the bike 100b. Additionally, the respective control of the generator 302a and the generator 302b can allow for each respective rider (of the bike 100a or the bike 100b) to experience a different exercise intensity or pedaling difficulty at the pedal assembly 195a and the pedal assembly 195b.

The control device 190a can receive information indicative of one or more operating parameters of the bike 100b. For example, the operating parameters can include one or more of the speed of the bike 100b, power output at the pedal assembly 195b, rider cadence or force applied to the pedal assembly 195b, loading of the generator 302b, or resistance applied by the generator 302b. The control device 190b can receive similar operating parameters with respect to the bike 100a. Based on the operating parameters (of the bike 100b), the control device 190a can adjust operation of the generator 302a. For example, the control device 190a can increase or decrease a resistive or motive force applied by the generator 302a to modify how much force is applied to the pedal assembly 195a to drive the bike 100a.

The control device 190a can adjust operation of the generator 302a such that a speed of the bike 100a substantially (for example, within ±10%) matches the speed of the bike 100b. The control device 190b can perform analogous operations based on operating parameters of the bike 100a. For example, the control device 190b can adjust operation of the generator 302b to control an amount of force required to operate the pedal assembly 195b so that the bike 100b remains at a desired distance relative to the bike 100a (for example, side-by-side or within a predetermined following distance).

For example, a first user (of the bike 100a) can achieve a high level of exercise intensity (relative to a second user of the bike 100a) as the control device 190a can operate the generator 302a such that the first user experiences (at the pedal assembly 195a) an opposing amount of torque or resistive force which results in high exertion by the first user. Stated otherwise, the first user (as a result of operation of the generator 302a) can experience a high pedaling load at the pedal assembly 195a. The control device 190a can command or operate the drive unit 155a (independent from the generator 302a) to maintain the speed of the bike 100a, regardless of or independent from the load experienced by the first user at the pedal assembly 195. This dual control of the generator 302a and the drive unit 155a can maintain the proximity between the bike 100a and the bike 100b even though the first user is experiencing (relative to the second user of the bike 100b) greater resistance and exerting more effort to propel the bike 100a.

A second user (of the bike 100b) can experience a lower level of exercise intensity (relative to the first user of the bike 100a) while the bike 100b travels at a substantially similar or same speed as the bike 100a. The control device 190b can operate the generator 302b to apply only a small opposing torque or resistive force (relative to the forces applied by the generator 302a) to the pedal assembly 195b. The second user (as a result of operation of the generator 302b) can experience a light pedaling load such that movement of the pedal assembly 195b (by the second user) requires minimal effort or less effort relative to that of first user of the bike 100a. The control device 190b can operate (separate from the generator 302b) the drive unit 155b such that the speed of the bike 100b is maintained independent from the load experienced at the pedal assembly 195b or the force applied to the pedal assembly 195b. The maintaining of the speed (of the bike 100b) can facilitate the bike 100b keeping up with or otherwise remaining within a given distance of the bike 100a even though the second user of the bike 100b is applying a lower force to the pedal assembly 195b.

The control device 190a and the control device 190b can adjust operation of the generator 302a and the generator 302b based on a measured separation distance, an estimated separation distance, or relative speeds of the bike 100a and the bike 100b. Additionally, communication between the control device 190a and the control device 190b can maintain the bike 100a and the bike 100b in close proximity. For example, the control device 190a and the control device 190b can automatically or continuously adjust loading of the generator 302a9at the pedal assembly 195a) and loading of generator 302b (at the pedal assembly 195b) such that each rider can achieve an individualized riding experience. For example, if the bike 100a begins to move ahead (beyond a predefined distance threshold) of the bike 100b, the control device 190a can operate the generator 302a to increase a resistive force at the pedal assembly 195a. The increase in the resistance force (at the pedal assembly 195a) can increase the difficulty for the rider of the bike 100a to increase speed further.

In parallel (or separately), the control device 190b can operate the generator 302b to decrease a resistive force at the pedal assembly 195b. The decrease in the resistive force (e.g., at the pedal assembly 195b) can make it easier for the rider of the bike 100b to increase speed and reduce the separation distance. Conversely, if the bike 100b moves too close to or ahead of the bike 100a, the control device 190a can reduce resistance at the pedal assembly 195a by reducing loading of the generator 302a. In parallel (or separately), the control device 190b can increase resistance at the pedal assembly 195b by increasing loading of the generator 302b, until the bike 100a and the bike 100b return to a desired relative position. Independent of the respective control of the generator 302a and the generator 302b, the control device 190a and the control device 190b can adjust operation of the drive unit 155a and the drive unit 155b to further finetune or maintain respective speeds or distances between the bike 100a and the bike 100b.

The control device 190a and the control device 190b can take into account rider-specific targets or constraints when adjusting the generator 302a and the generator 302b. For example, the rider of the bike 100a can select or be assigned a higher target exercise intensity level (for example, a higher target power output at the pedal assembly 195a). The control device 190a can set operation of the generator 302a so that maintaining the desired proximity to the bike 100b requires the rider of the bike 100a to maintain power output or pedal force within a corresponding high-intensity range at the pedal assembly 195a. As another example, the rider of the bike 100b can select or be assigned a lower intensity level. The control device 190b can set operation of the generator 302b so that the rider of the bike 100b maintains a lower-intensity range at the pedal assembly 195b while still maintaining the desired proximity to the bike 100a.

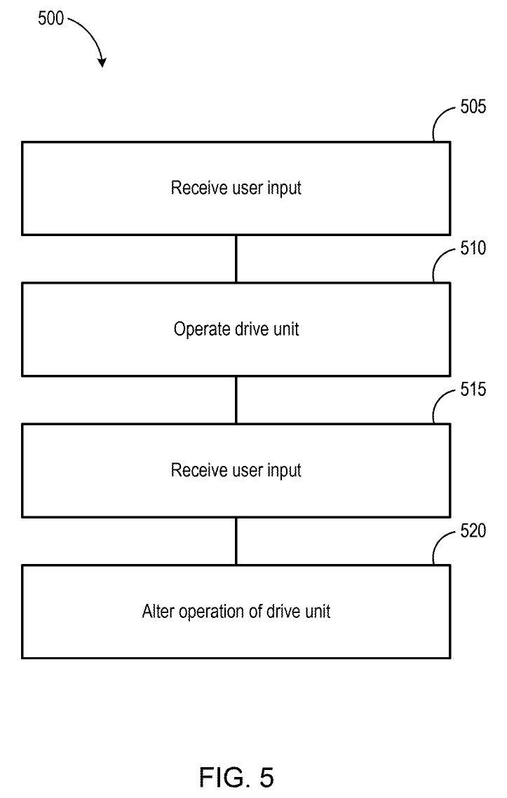

FIG. 5 depicts a flowchart of a method 500 of operating the bike 100. The method 500 can include one or more of acts 505–520. The acts 505–520 can be performed in the order depicted in FIG. 5, or in some other order. Any of acts 505–520 can be omitted, combined, separated, or otherwise altered.

The method 500 can include receiving an input, at act 505. The input can be provided by the user interface 192, the input device 398, or some other device that is communicatively coupled to the control device 190. The input can be a selection (by a user of the bike 100) of a workout program, training schedule, or other operating parameter by which the user desires the control device 190 to operate the bike 100. For example, the input can be a selection of a workout program to cause the generator 302 to require a certain force or forces (from the user) to rotate the pedal assembly 195 to drive the rear wheel 140b. Stated otherwise, the input provided by the user can be associated with a desired exercise intensity level or desired fitness outcome.

The method 500 can include operating a drive unit, at act 510. For example, the method 500 can include operating the drive unit 155 based on the input receive at act 505. The operation of the drive unit 155 can be mandated or controlled by the control device 190. For example, the control device 190 can cause the drive unit 155 to operate in a particular manner in order to affect a workout program, training schedule, or other operating parameter, as prescribed by the user input received at act 505. The control device 190 can cause the generator 302 to require that a certain force be applied (by the user) via the pedal assembly 195 in order to rotate the shaft 304 so as to modulate or specify a resistance experienced by the user while riding the bike 100.

The method 500 can include receiving an input, at act 515. For example, the method 500 can include receiving a second input from the user at act 515. The second input can be data or other information provided by the sensor 399 or some other device. For example, the second input can be sensed health related or biometric data that is measured by the sensor 399 during the operation of the bike 100 according to the operation of the drive unit 155 as discussed above at act 510. The input can be provided to the control device 190. For example, the sensor 399 can be communicably coupled with the control device 190 and can provide the second input on a continuous basis or at intervals, periodic or otherwise.

The second input (received at act 515) can be data associated with a parameter (e.g., heart rate, sweat rate, calories burned, skin temperature, or some other parameter) that is at least partially indicative of a level of intensity of exercise experienced by the user of the bike 100. The second input (received at act 515) can be an input provided via the input device 398, the user interface 192, or some other device other than the sensor 399. In other examples, the second input can be or include some combination of information or data provided by the sensor 399, the input device 398, the user interface 192, or some other device.

The method 500 can include altering an operation of the drive unit, at act 520. For example, the method 500 can include altering an operation of the drive unit 155 at act 520 based on the second input received at act 515. The control device 190 can alter an operation of the drive unit 155 in response to the second input so as to maintain a desired intensity of exercise as prescribed by the user input received an act 505. For example, the input received at act 505 can contemplate or require a particular heart rate level of the user. The control device 190 can cause the generator 302 to require a certain force be provided at the pedal assembly 195, where the certain force can maintain the user’s heart rate within a desired range.

During operation of the bike 100 (under these conditions), the sensor 399 can detect a current or updated heart rate of the user and transmit data indicative of that heart rate to the control device 190. Based on the updated heart rate, the control device 190 can either increase or decrease an amount of force required by the user via the pedal assembly 195 so as to bring the users rate into or closer to the desired heart rate range. In other examples, the control device 190 can require a greater amount or a lesser amount of force be provided by the user via the pedal assembly 195 based on the second input. In this way, the control device 190 can cause the bike 100 to operate in a particular manner and according to or in response to data or information provided to control device during operation of the bike 100.

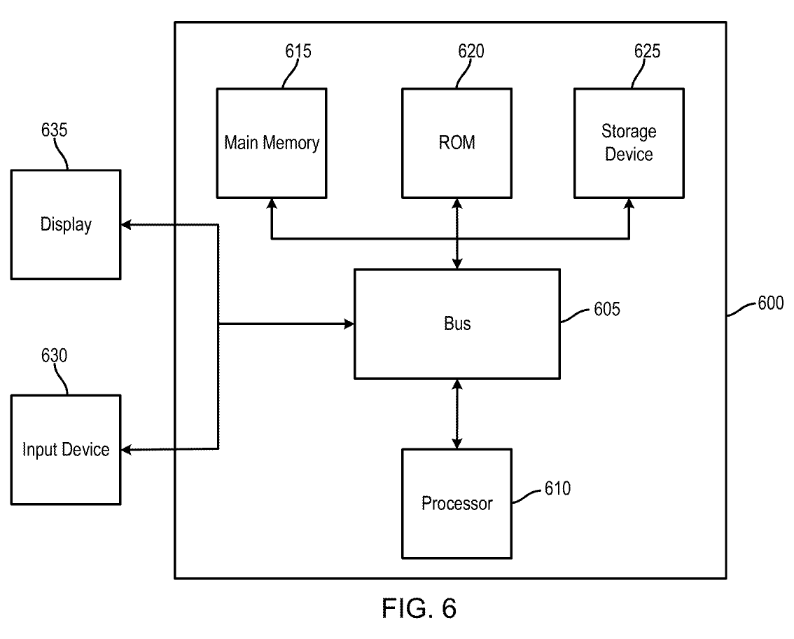

FIG. 6 is a block diagram illustrating an architecture for a computing system 600 that can be employed to implement elements of the systems and methods described and illustrated herein, including, for example, the bike 100, among others. For example, the control device 190 or some other control device of the bike 100 can be or include the computing system 600 can include at least one bus (shown as bus 605) or other communication component for communicating information and at least one processor (shown as processor 610) or processing circuit coupled to the bus 605 for processing information. The computing system 600 can also include the processor 610 or processing circuits coupled to the bus 605 for processing information. The computing system 600 also includes at least one main memory (shown as main memory 615), such as a random access memory (RAM) or other dynamic storage device, coupled to the bus 605 for storing information, and instructions to be executed by the processor 610. The main memory 615 can be used for storing information during execution of instructions by the processor 610. The computing system 600 may include at least one read only memory (shown as ROM 620) or other static storage device coupled to the bus 605 for storing static information and instructions for the processor 610. A storage device 625, such as a solid state device, magnetic disk or optical disk, can be coupled to the bus 605 to persistently store information and instructions.

The computing system 600 may be coupled via the bus 605 to a display 635, such as a liquid crystal display, or active matrix display, for displaying information to a user such as a rider of the bike 100 or other end user. An input device 630, such as a keyboard or voice interface may be coupled to the bus 605 for communicating information and commands to the processor 610. The input device 630 can include a touch screen (e.g., the display 635). The input device 630 can also include a cursor control, such as a mouse, a trackball, or cursor direction keys, for communicating direction information and command selections to the processor 610 and for controlling cursor movement on the display 635.

The processes, systems and methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. Hard-wired circuitry can be used in place of or in combination with software instructions together with the systems and methods described herein. Systems and methods described herein are not limited to any specific combination of hardware circuitry and software.

A bike can include a frame. The bike can include a first wheel and a second wheel. The first wheel and the second wheel can be rotatably coupled with the frame. The bike can include a drive unit. The drive unit can be coupled with the frame. The drive unit can include a first geartrain, a generator, a second geartrain, and a pedal assembly. The generator can include a shaft. The pedal assembly can be rotatably coupled with the shaft. The pedal assembly can rotate the shaft based on a required force provided by a user to the pedal assembly. The drive unit can be operatively coupled with the second wheel via the second geartrain. The pedal assembly can be selectively coupled with the second wheel via the first geartrain and the second geartrain. The drive unit can rotate the second wheel. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the required force in response to an input.

A bike can include a frame. The bike can include a first wheel and a second wheel. The first wheel and the second wheel can be rotatably coupled with the frame. The bike can include a drive unit. The drive unit can be coupled with the frame. The drive unit can include a first geartrain, a generator, a second geartrain, and a pedal assembly. The generator can include a shaft. The pedal assembly can be rotatably coupled with the shaft. The pedal assembly can rotate the shaft based on a required force provided by a user to the pedal assembly. The drive unit can be operatively coupled with the second wheel via the second geartrain. The pedal assembly can be selectively coupled with the second wheel via the first geartrain and the second geartrain. The drive unit can rotate the second wheel. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the required force in response to an input. The bike can include a user interface. The user interface can be communicably coupled with the control device. The user interface can be coupled with the frame of the bike/ The input can be provided by the user via the user interface. The input can include a selection of a workout program provided by the user via the user interface. The workout program can prescribe one or more forces to be provided to the pedal assembly to rotate the shaft of the generator.

A bike can include a frame. The bike can include a first wheel and a second wheel. The first wheel and the second wheel can be rotatably coupled with the frame. The bike can include a drive unit. The drive unit can be coupled with the frame. The drive unit can include a first geartrain, a generator, a second geartrain, and a pedal assembly. The generator can include a shaft. The pedal assembly can be rotatably coupled with the shaft. The pedal assembly can rotate the shaft based on a required force provided by a user to the pedal assembly. The drive unit can be operatively coupled with the second wheel via the second geartrain. The pedal assembly can be selectively coupled with the second wheel via the first geartrain and the second geartrain. The drive unit can rotate the second wheel. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the required force in response to an input. The bike can include a user interface. The user interface can be communicably coupled with the control device. The input can include (i) a first input provided by the user via the user interface and (ii) a second input provided by a sensor. The first include can include a selection of a workout program. The second input can be associated with biometric data of the user. The workout program can prescribe one or more forces to be provided by the user to the pedal assembly to rotate the shaft of the generator.

A bike can include a frame. The bike can include a first wheel and a second wheel. The first wheel and the second wheel can be rotatably coupled with the frame. The bike can include a drive unit. The drive unit can be coupled with the frame. The drive unit can include a first geartrain, a generator, a second geartrain, and a pedal assembly. The generator can include a shaft. The pedal assembly can be rotatably coupled with the shaft. The pedal assembly can rotate the shaft based on a required force provided by a user to the pedal assembly. The drive unit can be operatively coupled with the second wheel via the second geartrain. The pedal assembly can be selectively coupled with the second wheel via the first geartrain and the second geartrain. The drive unit can rotate the second wheel. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the required force in response to an input. The inputs can include one or more operating parameters of a second bike. The control device can receive, from the second bike, the one or more operating parameters of the second bike. The control device can determine, based at least on the one or more operating parameters, a distance between the bike and the second bike. The control device can adjust one or more operations of the generator to keep the distance within a predetermined threshold.

A bike can include a frame. The bike can include a first wheel and a second wheel. The first wheel and the second wheel can be rotatably coupled with the frame. The bike can include a drive unit. The drive unit can be coupled with the frame. The drive unit can include a first geartrain, a generator, a second geartrain, and a pedal assembly. The generator can include a shaft. The pedal assembly can be rotatably coupled with the shaft. The pedal assembly can rotate the shaft based on a required force provided by a user to the pedal assembly. The drive unit can be operatively coupled with the second wheel via the second geartrain. The pedal assembly can be selectively coupled with the second wheel via the first geartrain and the second geartrain. The drive unit can rotate the second wheel. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the required force in response to an input. The bike can be in communication, via a network, with at least one second bike. The control device can receive the input to indicate a distance threshold between the bike and the at least one second bike. The control device can control operation of the generator based at least on the distance threshold.

A system can include a bike. The bike can include a frame. The bike can include a first wheel and a second wheel. The first wheel and the second wheel can be coupled with the frame. The bike can include a drive unit. The drive unit can be coupled with the frame. The drive unit can include a generator and a pedal assembly. The pedal assembly can be rotatably coupled with a shaft of the generator. The pedal assembly can rotate the shaft based on a force provided to the pedal assembly. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the force provided to the pedal assembly in response to an input.

A system can include a bike. The bike can include a frame. The bike can include a first wheel and a second wheel. The first wheel and the second wheel can be coupled with the frame. The bike can include a drive unit. The drive unit can be coupled with the frame. The drive unit can include a generator and a pedal assembly. The pedal assembly can be rotatably coupled with a shaft of the generator. The pedal assembly can rotate the shaft based on a force provided to the pedal assembly. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the force provided to the pedal assembly in response to an input. The bike can include a user interface. The user interface can be communicably coupled with the control device. The user interface can be coupled with the frame of the bike. The input can be provided via the user interface. The input can include a selection of a workout program provided via the user interface. The workout program can prescribe one or more forces to be provided to the pedal assembly to rotate the shaft of the generator.

A system can include a bike. The bike can include a frame. The bike can include a first wheel and a second wheel. The first wheel and the second wheel can be coupled with the frame. The bike can include a drive unit. The drive unit can be coupled with the frame. The drive unit can include a generator and a pedal assembly. The pedal assembly can be rotatably coupled with a shaft of the generator. The pedal assembly can rotate the shaft based on a force provided to the pedal assembly. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the force provided to the pedal assembly in response to an input. The bike can include a user interface. The user interface can be communicably coupled with the control device. The input can include (i) a first input provided by via the user interface and (ii) a second input provided by a sensor. The first input can include a selection of a workout program. The second input can be associated with biometric data of a user. The workout program can prescribe one or more forces to be provided by the user to the pedal assembly to rotate the shaft of the generator.

A system can include a bike. The bike can include a frame. The bike can include a first wheel and a second wheel. The first wheel and the second wheel can be coupled with the frame. The bike can include a drive unit. The drive unit can be coupled with the frame. The drive unit can include a generator and a pedal assembly. The pedal assembly can be rotatably coupled with a shaft of the generator. The pedal assembly can rotate the shaft based on a force provided to the pedal assembly. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the force provided to the pedal assembly in response to an input. The input can include one or more operating parameters of a second bike. The control device can receive, from the second bike, the one or more operating parameters of the second bike. The control device can determine, based at least on the one or more operating parameters, a distance between the bike and the second bike. The control device can adjust one or more operations of the generator to keep the distance within a predetermined threshold.

A system can include a bike. The bike can include a frame. The bike can include a first wheel and a second wheel. The first wheel and the second wheel can be coupled with the frame. The bike can include a drive unit. The drive unit can be coupled with the frame. The drive unit can include a generator and a pedal assembly. The pedal assembly can be rotatably coupled with a shaft of the generator. The pedal assembly can rotate the shaft based on a force provided to the pedal assembly. The bike can include a battery. The battery can be detachably coupled with the frame. The battery can be operatively coupled with the drive unit. The battery can cause the drive unit to rotate the second wheel. The bike can include a control device. The control device can be operatively coupled to the drive unit. The control device can alter an operation of the generator to selectively vary the force provided to the pedal assembly in response to an input. The bike can be in communication, via a network, with at least one second bike. The control device can receive the input to indicate a distance threshold between the bike and the at least one second bike. The control device can control operation of the generator based at least on the distance threshold.

A method can include receiving, by a control device of a bike, a first input indicative of a workout program. The method can include operating, by the control device, based at least on the first input, a drive unit of the bike to rotate a wheel of the bike with a first amount of force input via a pedal assembly according to an operation of the bike. The method can include receiving, by the control device, via a sensor, a second input indicative of a biometric of a user. The method can include altering, by the control device, based on the second input, the operation of the bike to rotate the wheel of the bike with a second amount of force via the pedal assembly. The second amount of force can be different from the first amount of force.

A method can include receiving, by a control device of a bike, a first input indicative of a workout program. The method can include operating, by the control device, based at least on the first input, a drive unit of the bike to rotate a wheel of the bike with a first amount of force input via a pedal assembly according to an operation of the bike. The method can include receiving, by the control device, via a sensor, a second input indicative of a biometric of a user. The method can include altering, by the control device, based on the second input, the operation of the bike to rotate the wheel of the bike with a second amount of force via the pedal assembly. The second amount of force can be different from the first amount of force. The workout program can prescribe the first amount of force.

A method can include receiving, by a control device of a bike, a first input indicative of a workout program. The method can include operating, by the control device, based at least on the first input, a drive unit of the bike to rotate a wheel of the bike with a first amount of force input via a pedal assembly according to an operation of the bike. The method can include receiving, by the control device, via a sensor, a second input indicative of a biometric of a user. The method can include altering, by the control device, based on the second input, the operation of the bike to rotate the wheel of the bike with a second amount of force via the pedal assembly. The second amount of force can be different from the first amount of force. The first input can include one or more operating parameters of a second bike. The method can include receiving, by the control device, from the second bike, the one or more operating parameters of the second bike. The method can include determining, by the control device, based at least on the one or more operating parameters, a distance between the bike and the second bike. The method can include adjusting, by the control device, one or more operations of a generator of the bike to keep the distance within a predetermined threshold.

A method can include receiving, by a control device of a bike, a first input indicative of a workout program. The method can include operating, by the control device, based at least on the first input, a drive unit of the bike to rotate a wheel of the bike with a first amount of force input via a pedal assembly according to an operation of the bike. The method can include receiving, by the control device, via a sensor, a second input indicative of a biometric of a user. The method can include altering, by the control device, based on the second input, the operation of the bike to rotate the wheel of the bike with a second amount of force via the pedal assembly. The second amount of force can be different from the first amount of force. The bike can be in communication, via a network, with at least one second bike. The method can include receiving, by the control device, the first input to indicate a distance threshold between the bike and the at least one second bike. The method can include controlling, by the control device, operation of a generator of the bike based at least on the distance threshold.

The micromobility device 100 can be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component,” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, or elements, or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms, as used herein, are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/-10% or +/-10 degrees of pure vertical, parallel or perpendicular positioning. References to “approximately,” “substantially,” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A bike, comprising:
a frame;
a first wheel and a second wheel rotatably coupled with the frame;
a drive unit coupled with the frame, the drive unit including a first geartrain, a generator, a second geartrain, and a pedal assembly, the generator including a shaft, the pedal assembly rotatably coupled with the shaft to rotate the shaft based on a required force provided by a user to the pedal assembly, the drive unit operatively coupled with the second wheel via the second geartrain, the pedal assembly selectively coupled with the second wheel via the first geartrain and the second geartrain, the drive unit to rotate the second wheel;
a battery detachably coupled with the frame and operatively coupled with the drive unit, the battery to cause the drive unit to rotate the second wheel; and
a control device operatively coupled to the drive unit, the control device to alter an operation of the generator to selectively vary the required force in response to an input.

2. The bike of claim 1, comprising:
a user interface communicably coupled with the control device and coupled with the frame of the bike;
wherein the input is provided by the user via the user interface.

3. The bike of claim 1, comprising:
a user interface communicably coupled with the control device and coupled with the frame of the bike; and
the input including a selection of a workout program provided by the user via the user interface, the workout program prescribing one or more forces to be provided to the pedal assembly to rotate the shaft of the generator.

4. The bike of claim 1, wherein the input includes a selection of a workout program, wherein the workout program prescribes one or more forces to be provided to the pedal assembly to rotate the shaft of the generator, and wherein the one or more forces are to cause the user to experience a desired level of fitness activity during an operation of the bike.

5. The bike of claim 1, comprising:
a user interface communicably coupled with the control device; and
the input including (i) a first input provided by the user via the user interface and (ii) a second input provided by a sensor;
wherein the second input is associated with biometric data of the user.

6. The bike of claim 1, comprising:
a user interface communicably coupled with the control device; and
the input including (i) a first input provided by the user via the user interface and (ii) a second input provided by a sensor, wherein the first input includes a selection of a workout program, and wherein the second input is associated with biometric data of the user;
wherein the workout program prescribes one or more forces to be provided by the user to the pedal assembly to rotate the shaft of the generator.

7. The bike of claim 1, comprising:
the control device to increase a current load of the generator to cause the required force to increase.

8. The bike of claim 1, wherein the input includes one or more operating parameters of a second bike, and comprising:
the control device to:
receive, from the second bike, the one or more operating parameters of the second bike;
determine, based at least on the one or more operating parameters, a distance between the bike and the second bike; and
adjust one or more operations of the generator to keep the distance within a predetermined threshold.

9. The bike of claim 1, wherein the bike is in communication, via a network, with at least one second bike, and comprising:
the control device to:
receive the input to indicate a distance threshold between the bike and the at least one second bike; and
control operation of the generator based at least on the distance threshold.

10. A system, comprising:
a bike, including:
a frame;
a first wheel and a second wheel rotatably coupled with the frame;
a drive unit coupled with the frame, the drive unit including a generator and a pedal assembly;
the pedal assembly rotatably coupled with a shaft of the generator to rotate the shaft based on a force provided to the pedal assembly;
a battery detachably coupled with the frame and operatively coupled with the drive unit, the battery to cause the drive unit to rotate the second wheel; and
a control device operatively coupled to the drive unit, the control device to alter an operation of the generator to selectively vary the force provided to the pedal assembly in response to an input.

11. The system of claim 10, comprising:
a user interface communicably coupled with the control device and coupled with the frame of the bike;
wherein the input is provided via the user interface.

12. The system of claim 10, comprising:
a user interface communicably coupled with the control device and coupled with the frame of the bike; and
the input including a selection of a workout program provided via the user interface, the workout program prescribing one or more forces to be provided to the pedal assembly to rotate the shaft of the generator.

13. The system of claim 10, comprising:
a user interface communicably coupled with the control device; and
the input including (i) a first input provided via the user interface and (ii) a second input provided by a sensor;
wherein the second input is associated with biometric data of a user.

14. The system of claim 10, comprising:
a user interface communicably coupled with the control device; and
the input including (i) a first input provided by via the user interface and (ii) a second input provided by a sensor, wherein the first input includes a selection of a workout program, and wherein the second input is associated with biometric data of a user;
wherein the workout program prescribes one or more forces to be provided by the user to the pedal assembly to rotate the shaft of the generator.

15. The system of claim 10, wherein the input includes one or more operating parameters of a second bike, and comprising:
the control device to:
receive, from the second bike, the one or more operating parameters of the second bike;
determine, based at least on the one or more operating parameters, a distance between the bike and the second bike; and
adjust one or more operations of the generator to keep the distance within a predetermined threshold.

16. The system of claim 10, wherein the bike is in communication, via a network, with at least one second bike, and comprising:
the control device to:
receive the input to indicate a distance threshold between the bike and the at least one second bike; and
control operation of the generator based at least on the distance threshold.

17. A method, comprising:
receiving, by a control device of a bike, a first input indicative of a workout program;
operating, by the control device, based at least on the first input, a drive unit of the bike to rotate a wheel of the bike with a first amount of force input via a pedal assembly according to an operation of the bike;
receiving, by the control device, via a sensor, a second input indicative of a biometric of a user; and
altering, by the control device, based on the second input, the operation of the bike to rotate the wheel of the bike with a second amount of force via the pedal assembly, the second amount of force different from the first amount of force.

18. The method of claim 17, wherein the workout program prescribes the first amount of force.

19. The method of claim 17, wherein the first input includes one or more operating parameters of a second bike, and comprising:
receiving, by the control device, from the second bike, the one or more operating parameters of the second bike;
determining, by the control device, based at least on the one or more operating parameters, a distance between the bike and the second bike; and
adjusting, by the control device, one or more operations of a generator of the bike to keep the distance within a predetermined threshold.

20. The method of claim 17, wherein the bike is in communication, via a network, with at least one second bike, and comprising:
receiving, by the control device, the first input to indicate a distance threshold between the bike and the at least one second bike; and
controlling, by the control device, operation of a generator of the bike based at least on the distance threshold.
